(19) United States
(12) Patent Application Publication
(10) Pub. No.: US 2023/0237673 A1
(43) Pub. Date: Jul. 27, 2023

(54) MOBILE PHOTOELECTRIC DETECTION AND IDENTIFICATION SYSTEM FOR LOW, SLOW AND SMALL TARGETS

(71) Applicant: Huazhong University of Science and Technology, Wuhan (CN)

(72) Inventors: Tianxu ZHANG, Wuhan (CN); Yiguang ZHANG, Wuhan (CN); Lianjie LU, Wuhan (CN); Chuanyi WEN, Wuhan (CN); Hai XU, Wuhan (CN); Yingzhuang LIU, Wuhan (CN); Jian LIU, Wuhan (CN); Tiejun ZHANG, Wuhan (CN)

(21) Appl. No.: 18/159,898

(22) Filed: Jan. 26, 2023

(30) Foreign Application Priority Data
Jan. 26, 2022 (CN) 2022100904886

(51) Int. Cl. G06T 7/20; G01C 11/00; G01S 7/48; G01S 7/481; G06T 1/20

(52) U.S. Cl. CPC G06T 7/20; G01C 11/00; G01S 7/4802; G01S 7/481; G06T 1/20; G06T 2207/10048; G06T 2207/20221

(57) ABSTRACT

The disclosure discloses a mobile photoelectric detection and identification system for low, slow and small targets. The optical detection subsystem and the photoelectric parallel processing and identification subsystem are arranged on the servo subsystem, and the servo subsystem is carried on an installation platform of a vehicle. The optical detection subsystem is configured to collect multi-wavelength band optical information from the target and the background. The co-processing module of various wavelength bands is configured to perform single-frame detection and identification of the target from the image information of the corresponding wavelength band. The information processing main control module is configured to use JPEG image compression, track association and multi-frame combining methods to perform a multi-frame detection and identification on the target. The servo subsystem is configured to complete target tracking according to the multi-frame detection and identification results.

### CROSS-REFERENCE TO RELATED APPLICATION

This application claims the priority benefit of China application serial no. 202210090488.6, filed on Jan. 26, 2022. The entirety of the above-mentioned patent application is hereby incorporated by reference herein and made a part of this specification.

### BACKGROUND

### Technical Field

The disclosure belongs to the technical field of aircraft detection, and more specifically relates to a mobile photoelectric detection and identification system for low, slow and small targets.

### Description of Related Art

In recent years, the further development and popularization of unmanned aerial vehicle (UAV) and small aircraft technology have brought about wrong use of UAV and related technology, which makes all kinds of typical aerial unmanned aerial vehicles, small aircraft and air balloons pose a serious threat, such as airport airspace hazard, to people and properties in some special scenarios.

At present, the detection and identification system for early warning of low, slow and small targets in the air is mainly ground-based. Because of the small radar reflection area of the typical low, slow and small target in the air, it is difficult for ground-based radars to realize effective detection of low, slow and small targets in the air due to the influence of low-altitude background clutter. The existing ground-based photoelectric detection equipment mainly adopts single-wavelength band infrared detection or dual-wavelength band detection to capture or identify targets, and domestic and foreign detection platforms are mainly fixed at specific locations to detect and identify targets. Due to the shortcomings of low mobile deployment ability, low detection rate in single-wavelength band or dual-wavelength band and high false alarm rate, it is impossible to realize target detection and identification under long-range conditions, and there is a lack of situational awareness capability of a wide range of scenarios.

Therefore, how to make improvement on low mobile deployment ability, low detection and identification accuracy, and limited detection range of the conventional detection system for low, slow and small targets is an urgent problem to be solved.

### SUMMARY

In view of the defects of the related art, the purpose of the present disclosure is to provide a mobile photoelectric detection and identification system for low, slow and small targets with high detection and identification accuracy, high maneuverability and long-range detection.

In order to achieve the above purpose, the present disclosure provides a mobile photoelectric detection and identification system for low, slow and small targets, including an optical detection subsystem, a photoelectric parallel processing and identification subsystem and a servo subsystem. The optical detection subsystem and the photoelectric parallel processing and identification subsystem are arranged on the servo subsystem, and the servo subsystem is carried on an installation platform of a vehicle.

The optical detection subsystem is configured to collect multi-wavelength band optical information from the target and the background. The multi-wavelength band optical information includes multi-wavelength band image information, laser ranging information and infrared wide spectrum information. The multi-wavelength band image information includes long-wavelength infrared image information, mid-wavelength infrared image information, short-wavelength infrared image information and visible light image information.

The photoelectric parallel processing and identification subsystem includes a multi-wavelength band image co-processing module and an information processing main control module. The co-processing modules of various wavelength bands are configured to perform single-frame detection and identification of the target from the image information of the corresponding wavelength band by means of single-frame suppression and multi-frame differential suppression of sky background clutter. The information processing main control module is configured to use JPEG image compression, track association and multi-frame combining methods to perform multi-frame detection and identification on the target according to the laser range measurement information, infrared wide spectrum information, image information of various wavelength bands and the single-frame detection and identification results of the co-processing module of various wavelength bands, and feedback the multi-frame detection and identification results to the image co-processing modules of various wavelength bands and the servo subsystem. The multi-frame detection and identification results include the orientation information, speed information, height information and position information of the target.

The servo subsystem is configured to complete target tracking according to the multi-frame detection and identification results.

The mobile photoelectric detection and identification system for low, slow and small targets provided by the present disclosure has the following effects: (1) All subsystems of the system are integrated on the vehicle, thus having high mobility and transfer capabilities, rapid operating and withdrawal capability, and extremely high deployment capability; (2) By using multi-wavelength band optical information, adopting JPEG image compression method, track association and multi-frame combining method to perform multi-frame detection and identification on the target, it is possible to effectively improve the accuracy of target detection and identification; (3) With the addition of a servo subsystem, and under the cooperative work of the servo subsystem, the optical detection subsystem and the photoelectric parallel processing and identification subsystem, it is possible to realize the detection and long-term stable tracking, spectrum measurement, ranging and identification of long-range targets on the ground, in the sea and air.

In one of the embodiments, the optical detection subsystem includes an optical window and a laser emitting module, a six-wavelength band common-aperture Cassegrain reflection module, a beam splitting module, and a six-wavelength band detection module arranged sequentially behind the optical window. The beam splitting module includes a plurality of reflective and refractive lenses. The six-wavelength band detection module includes a long-wavelength infrared detection module, a mid-wavelength infrared detection module, a short-wavelength infrared detection module, a visible light detection module, a laser receiving module, and an infrared wide spectrum measurement module. The laser emitting module, the laser receiving module and the infrared wide spectrum measurement module are respectively electrically connected to the information processing main control module, and the long-wavelength infrared detection module, the mid-wavelength infrared detection module, the short-wavelength infrared detection module and the visible light detection module are electrically connected with the image co-processing module of the corresponding wavelength band.

In one of the embodiments, the primary optical aperture of the six-wavelength band common-aperture Cassegrain reflection module is greater than or equal to 500 mm. The emission wavelength band of the laser emitting module is 1.54 μm. The detection wavelength band of the long-wavelength infrared detection module is 8 to 14 μm. The detection wavelength band of the mid-wavelength infrared detection module is 3 to 5 μm. The detection wavelength band of the short-wavelength infrared detection module is 1.3 to 2.2 μm. The detection wavelength band of the visible light detection module is 0.45 to 0.75 μm. The spectrum measurement wavelength band of the infrared wide spectrum measurement module is 1.7 to 14 μm.

In one of the embodiments, the servo subsystem includes a two-axis high-precision control turntable and a servo main control module. The servo main control module is electrically connected to the two-axis high-precision control turntable and the information processing main control module respectively. The two-axis high-precision control turntable is equipped with a load U-shaped frame, the optical detection subsystem is arranged in the U-shaped frame, and the modules in the photoelectric parallel processing and identification subsystem are divided into two information processing chambers arranged on both sides of the U-shaped frame.

In one of the embodiments, the servo subsystem, the optical detection subsystem, and the photoelectric parallel processing and identification subsystem are simultaneously arranged in a servo cabin dome cover, and the servo cabin dome cover is provided with a window that moves with the detection direction of the optical detection subsystem.

In one of the embodiments, an information transmission and communication subsystem is further included. The information transmission and communication subsystem includes a switch, a communication main control module and an external transmission module. The switch is electrically connected to the communication main control module, the information processing main control module, and the servo main control module respectively.

During operation, the information processing main control module is configured to compress and encode the multi-wavelength band optical information and multi-frame detection and identification results into transmission packets in a specific format and forward them to the switch. The switch is configured to transfer all encoded transmission packets to the communication main control module, and the communication main control module is configured to complete the scheduling and external transmission of all transmission packets.

In one of the embodiments, the external transmission module includes a satellite communication module, a mobile communication module, a wireless transmission module, or an optical access module. The satellite communication module, the mobile communication module, and the wireless transmission module respectively exchange information with each other through an antenna, a control center or other mobile photoelectric detection and identification systems. The optical access module exchanges information with the control center or other mobile photoelectric detection and identification systems through optical fibers; and the antenna is arranged on both sides of the servo cabin dome cover.

In one of the embodiments, the vehicle is provided with an integrated control computer and an electric control module, and the integrated control computer is electrically connected to the switch and the electric control module respectively.

The integrated control computer is configured to obtain the operation status of various subsystems and various modules in the mobile photoelectric detection and identification system in real time. The electric control module includes an electric control cabinet and a diesel generator set, and has two power supply modes: direct power supply from mains electricity and diesel power.

In one of the embodiments, the bottom of the installation platform is equipped with leveling legs, and the leveling legs are configured to realize the leveling and adjustment of the installation plane of the installation platform.

The servo subsystem further includes a positioning and orientation module and a servo fine leveling module. The positioning and orientation module is configured to acquire the position and direction information of the optical detection subsystem. The servo main control module is configured to control the servo fine leveling module according to the position and direction information to realize the leveling control of the optical detection subsystem.

In one of the embodiments, the vehicle is further equipped with a crane and a remote control device, and the crane is electrically connected with the remote control device and the integrated control computer respectively. The crane is configured to receive the lifting command of the remote control device or the integrated control computer to complete the lifting operation of the diesel generator set or the servo cabin dome cover.

### BRIEF DESCRIPTION OF THE DRAWINGS

FIG. 1 is a schematic principle diagram of a mobile photoelectric detection and identification system for low, slow and small targets according to an embodiment of the present disclosure.

FIG. 2 is a schematic diagram of the integration of an optical detection subsystem, a photoelectric parallel processing subsystem and a servo subsystem according to an embodiment of the present disclosure.

FIG. 3 is a three-dimensional structure diagram of a servo cabin dome cover according to an embodiment of the present disclosure.

FIG. 4 is a three-dimensional layout diagram of a mobile photoelectric detection and identification system for low, slow and small targets according to an embodiment of the present disclosure.

FIG. 5 is a structural diagram of a crane according to an embodiment of the present disclosure.

FIG. 6 to FIG. 8 are schematic diagrams of three operation conditions of a mobile photoelectric detection and identification system for low, slow and small targets according to the present disclosure.

FIG. 9 is a schematic diagram of a cockpit station layout of a mobile photoelectric detection and identification system for low, slow and small targets according to an embodiment of the present disclosure.

FIG. 10 is a schematic flow chart of detection of air targets by a mobile photoelectric detection and identification system for low, slow and small targets according to an embodiment of the present disclosure.

### DESCRIPTION OF THE EMBODIMENTS

In order to make the purpose, technical solution and advantages of the present disclosure more comprehensible, the present disclosure will be further described in detail below in conjunction with the accompanying drawings and embodiments. It should be understood that the specific embodiments described here are only used to explain the present disclosure, not to limit the present disclosure.

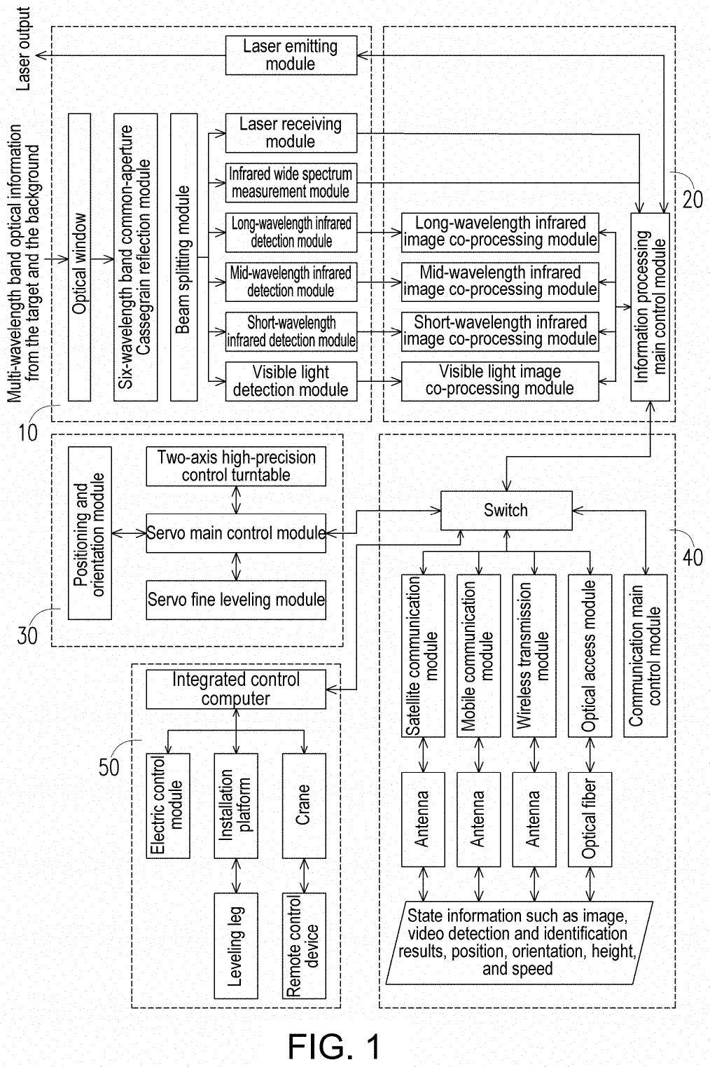

In order to solve the problem of low mobile deployment ability, low detection and identification accuracy, and limited detection range of the conventional detection system for low, slow and small targets, the present disclosure provides a mobile photoelectric detection and identification system for low, slow and small targets. As shown in FIG. 1, the mobile photoelectric detection and identification system includes an optical detection subsystem 10, a photoelectric parallel processing and identification subsystem 20 and a servo subsystem 30.

The optical detection subsystem 10 and the photoelectric parallel processing and identification subsystem 20 are arranged on the servo subsystem 30, and the servo subsystem 30 is mounted on an installation platform of a vehicle 50.

In this embodiment, the optical detection subsystem 10 and the photoelectric parallel processing and identification subsystem 20 are configured to carry out photoelectric detection and identification of targets. The servo subsystem 30 is configured to track the target according to the results of photoelectric detection and identification of targets.

In this embodiment, the optical detection subsystem 10, the photoelectric parallel processing and identification subsystem 20, and the servo subsystem 30 are integrated on the vehicle 50. During operation, because the whole machine is highly integrated on the vehicle 50, the driver may directly drive the equipment to achieve rapid transfer. After arriving at the designated place, the operation is carried out and photoelectric detection and identification of targets is conducted. After the operation is finished, the staff may control and realize the withdrawal of the whole machine, and drive the equipment to the designated place, so that the mobile photoelectric detection and identification system provided by this embodiment has high mobile transfer capability, rapid operating and withdrawal capability, and extremely high deployment capability.

In order to improve the accuracy of detecting and identifying targets by the optical detection subsystem 10 and photoelectric parallel processing and identification subsystem 20, the optical detection subsystem 10 provided by the present disclosure is configured to collect multi-wavelength band optical information from the target and the background. The multi-wavelength band optical information includes multi-wavelength band image information, laser ranging information and infrared wide spectrum information. The multi-wavelength band image information includes long-wavelength infrared image information, mid-wavelength infrared image information, short-wavelength infrared image information, and visible light image information. Certainly, the multi-wavelength band image information may further include image information of other wavelength bands, which is not limited in this embodiment. In order to explain this solution more clearly, it is exemplified that the present disclosure uses the optical detection subsystem 10 to collect six-wavelength band optical information from the target and the background to describe the principle of target detection and identification completed by the present disclosure.

The photoelectric parallel processing and identification subsystem 20 is configured to process the six-wavelength band optical information collected by the optical detection subsystem 10 in real-time in parallel through wavelength band division. Specifically, the photoelectric parallel processing and identification subsystem 20 includes a four-wavelength band image co-processing module and an information processing main control module.

The long-wavelength infrared, mid-wavelength infrared, short-wavelength infrared and visible light image information collected by the optical detection subsystem 10 are transmitted to the image co-processing module of the corresponding wavelength band. After each of the image co-processing modules receives the image information of the corresponding wavelength band, the image co-processing module detects and identifies targets by combining single-frame suppression and multi-frame differential suppression of sky background clutter. After the information processing main control module receives the detection and identification result of each of the image co-processing modules, the information processing main control module combines laser ranging information, infrared wide spectrum information, four-wavelength band image information, and detection and identification results to further detect and identify the target, and feedbacks and transmits the detection and identification results to each of the image co-processing modules to facilitate mutual guidance of various wavelength bands for target detection and identification. In the meantime, the information processing main control module will also transmit the detection and identification results to the servo subsystem 30, and the servo subsystem 30 will complete tracking of target.

Since the detection and identification of the target by each of the image co-processing modules is single-frame detection and identification, and the target moves in a continuous manner, if a “suspected target” does not appear in the field of view for a long time, the “suspected target” will be excluded as a false alarm. In the actual implementation process of the present disclosure, multiple frames of image information will be combined, preferably 10 frames of image information, to maximize the exclusion of false alarms and ensure the accuracy of early warning. Only the same “suspected target” which appears continuously in 10 frames will be considered to be the real target. Therefore, the information processing main control module provided in this embodiment adopts track association and multi-frame combination to perform multi-frame detection and identification of the target. In the meantime, in order to further improve the accuracy of target detection and identification, the information processing main control module provided in this embodiment performs lossless compression encoding on the suspected target region of the image by using the JPEG image compression method while performing track association. Lossy compression coding is performed in the background region to achieve lossy/lossless compression of images.

The mobile photoelectric detection and identification system for low, slow and small targets provided by the embodiment has the following effects: (1) All subsystems of the system are integrated on the vehicle 50, thus having high mobility and transfer capabilities, rapid operating and withdrawal capability, and extremely high deployment capability; (2) By using multi-wavelength band optical information, adopting JPEG image compression method, track association and multi-frame combining method to perform multi-frame detection and identification on the target, it is possible to effectively improve the accuracy of target detection and identification; (3) With the addition of a servo subsystem 30, and under the cooperative work of the servo subsystem 30, the optical detection subsystem 10 and the photoelectric parallel processing and identification subsystem 20, it is possible to realize the detection and long-term stable tracking, spectrum measurement, ranging and identification of long-range targets on the ground, in the sea and air.

In an embodiment, the optical detection subsystem 10 includes an optical window and a laser emitting module, a six-wavelength band common-aperture Cassegrain reflection module, a beam splitting module, and a six-wavelength band detection module arranged sequentially behind the optical window. The beam splitting module includes a plurality of reflective and refractive lenses. The six-wavelength band detection module includes a long-wavelength infrared detection module, a mid-wavelength infrared detection module, a short-wavelength infrared detection module, a visible light detection module, a laser receiving module, and an infrared wide spectrum measurement module. The laser emitting module, the laser receiving module and the infrared wide spectrum measurement module are respectively electrically connected to the information processing main control module, and the long-wavelength infrared detection module, the mid-wavelength infrared detection module, the short-wavelength infrared detection module and the visible light detection module are electrically connected with the image co-processing module of the corresponding wavelength band.

During operation, after the optical window receives the six-wavelength band optical information, the six-wavelength band common-aperture Cassegrain reflection module set behind the optical window reflects and converges the multi-wavelength band optical information into the beam splitting module. The beam splitting module contains multiple reflective and refractive lenses, projects the infrared wide spectrum in the center of the field of view to the infrared wide spectrum measurement module in sequence, and splits the long-wavelength infrared wavelength band optical information into long-wavelength infrared detection module, splits the mid-wavelength infrared wavelength band optical information into mid-wavelength infrared detection module, splits the visible light wavelength band optical information into visible light detection module, splits the short-wavelength infrared wavelength band optical information into short-wavelength infrared detection module, and splits the laser ranging wavelength band optical information into the laser receiving module.

The photoelectric parallel processing and identification subsystem 20 is able to process the optical information transmitted by the optical detection subsystem 10 in real-time in parallel through wavelength band division. The output data of the visible light detection module is transmitted to the visible light image co-processing module, the output data of the short-wavelength infrared detection module is transmitted to the short-wavelength infrared image co-processing module, the output data of the mid-wavelength infrared detection module is transmitted to the mid-wavelength infrared image co-processing module, the output data of the long-wavelength infrared detection module is transmitted to the long-wavelength infrared image co-processing module, and the four image co-processing modules work separately in parallel to input the output results to the information processing main control module. In the meantime, one output of the information processing main control module is connected to the laser emitting module, the output data of the infrared wide spectrum measurement module and the output data of the laser receiving module are input to the information processing main control module. After the laser light emitted by the laser emitting module is emitted through the target/background, the emitted the laser light enters the optical window, the six-wavelength band common-aperture Cassegrain reflection module, and the beam splitting module, and is received by the laser receiving module.

The detection and identification results of the image co-processing modules of various wavelength bands will be input to the information processing main control module. The information processing main control module uses the laser ranging information, infrared wide spectrum information, four-wavelength band image information and the detection and identification results of the image co-processing modules of various wavelength bands to realize multi-wavelength band combining detection, and the detection results will be fed back to each of the image co-processing modules to facilitate mutual guidance of various wavelength bands for detection and identification of target.

Specifically, the chassis of the vehicle may be selected from Xiaolong's XLW-TB off-road vehicle special chassis, and other subsystems or modules may be reasonably arranged and integrated on the installation platform of the vehicle. In order to make full use of multi-wavelength band optical information to improve the accuracy and range of target detection and identification, the laser emission wavelength band may be specifically designed to be 1.54 μm, and the infrared wide spectrum may have a detection wavelength band of 1.7 to 14 μm as well as a spectral resolution of up to 4 wavenumbers. The visible light having 0.45 to 0.75 μm wavelength band, the short-wavelength infrared having 1.3 to 2.2 μm wavelength band, the mid-wavelength infrared having 3 to 5 μm wavelength band, and the long-wavelength infrared having 8 to 14 μm wavelength band may be selected. In addition, the main optical aperture designed by the present disclosure is not less than 500 mm, thereby ensuring that the detection ranges of the medium wavelength band and long wavelength band are not less than 120 km, that is, the whole machine may have the ability to detect targets on ground, in the sea and air within a radius of 120 km.

In order to enable the photoelectric parallel processing and identification subsystem 20 to have the capability of processing multi-wavelength band image target detection and identification in real time, each of the wavelength band image co-processing module may adopt FPGA+DSP+dedicated ASIC+NPU architecture, in which DSP and dedicated ASIC are mainly used to realize detection of aerial targets based on conventional methods, and FPGA and NPU are mainly used to implement deep neural network on hardware to realize identification of target. After the information processing main control module receives the result of each of the image co-processing module, the information processing main control module will feed back the target position information and motion state information to other image co-processing modules, and each of the image co-processing modules may detect and identify results through other frames to guide itself to perform detection and identification. Finally, the information processing main control module may integrate multi-wavelength band information, range information, and spectral information to realize further identification of the target. After confirming the sole target, the target orientation information and speed information are transmitted to the servo subsystem 30, and target tracking is completed by the servo subsystem 30.

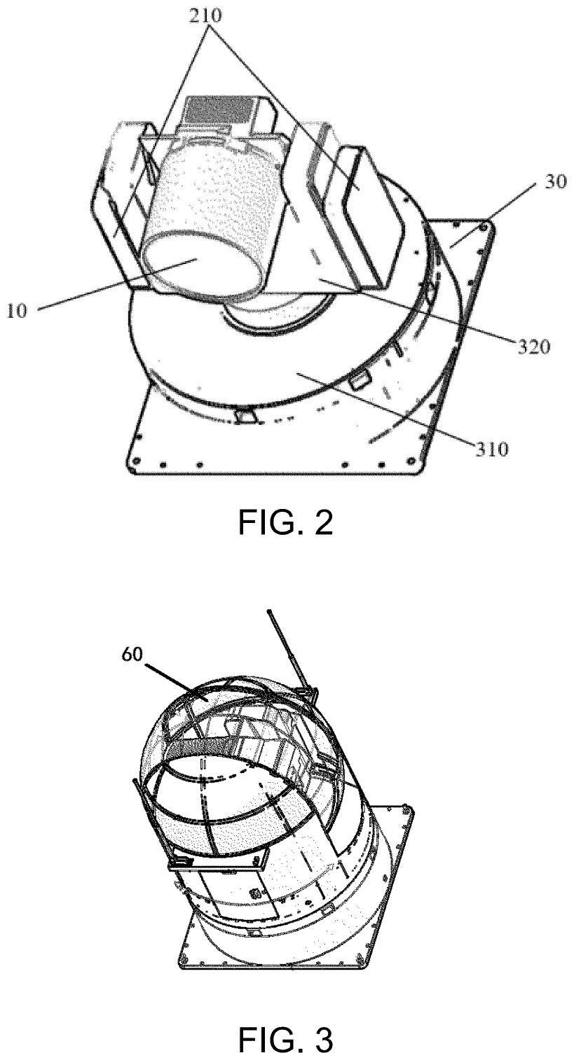

In an embodiment, in order to achieve high integration of equipment, as shown in FIG. 2, the servo subsystem 30 may include a two-axis high-precision control turntable 310 and a servo main control module. The servo main control module is electrically connected with the two-axis high-precision control turntable 310 and the information processing main control module respectively. The two-axis high-precision control turntable 310 is provided with a load U-shaped frame 320, the optical detection subsystem 10 is arranged in the U-shaped frame 320, and the multiple modules in the photoelectric parallel processing and identification subsystem 20 are divided into two information processing chambers 210 arranged on both sides of the U-shaped frame 320. In this embodiment, the two-axis high-precision control turntable 310 allows the optical detection subsystem 10 and the photoelectric parallel processing and identification subsystem 20 to move and rotate with the equipment together, thereby ensuring that the entire optical detection has the detection capability of 360-degree detection on the azimuth axis and the pitch axis is not lower than −5 to 185 degrees.

Further, as shown in FIG. 3, the servo subsystem 30, the optical detection subsystem 10 and the photoelectric parallel processing and identification subsystem 20 may be placed in the servo cabin dome cover 60 simultaneously. A window that moves with the detection direction of the optical detection subsystem 10 is opened on the servo cabin dome cover 60, that is, the servo cabin dome cover 60 only has a small window in the detection direction when it is working, so that there is no obstruction during the entire detection process. Moreover, it is possible to ensure that the above three subsystems are protected from external wind and is able to maintain continuous and stable working ability under windy conditions. In addition, due to the design of the closed servo cabin dome cover, the above three subsystems will be less affected by the external air salt spray and sand dust.

In an embodiment, in order to ensure the information intercommunication between various subsystems and modules and the information transmission between the whole machine and the control center or other equipment, as shown in FIG. 1, the whole machine is also equipped with an independent information transmission and communication subsystem 40. The information transmission and communication subsystem 40 includes a switch, a communication main control module and an external transmission module. The switch is electrically connected to the communication main control module, the information processing main control module, and the servo main control module respectively. Specifically, the external transmission module may include a satellite communication module, a mobile communication module, a wireless transmission module or an optical access module. The satellite communication module, mobile communication module, and wireless transmission module exchange information with the antenna, the control center or other mobile photoelectric detection and identification systems. The optical access module exchange information with or other mobile photoelectric detection and identification systems through optical fiber.

In this embodiment, the information transmission and communication subsystem 40 may ensure that multiple internal modules and subsystems are interconnected, and at the same time have the ability to perform information transmission and real-time image transmission externally. The information processing main control module in the photoelectric parallel processing and identification subsystem 20, the servo main control module in the servo subsystem 30, and the communication main control module in the information transmission and communication subsystem 40 are all connected to the switch, and the subsystems may perform status self-inspection, instruction transmission or image transmission through the switch. When the whole machine is working, the information processing main control module in the photoelectric parallel processing and identification subsystem 20 will complete the compression of optical information of various wavelength bands, and compress and encode the spectrum, images of various wavelength bands, ranging information and multi-frame detection and identification result into a transmission packet in a specific format, and forward the transmission packet into the switch. All encoded transmission packets are sent to the communication main control module through the switch, and the communication main control module completes the scheduling and external transmission of all packets.

Furthermore, the information transmission and communication subsystem 40 may realize cooperative detection performed jointly by multiple machines: specific multiple fixed deployment points are selected, after driving each mobile photoelectric detection and identification system to each designated deployment point, each machine may perform detection independently. When a stand-alone machine successfully detects and identifies the target, the stand-alone machine may transmit information such as the position, orientation, height, and speed of the target to the mobile photoelectric detection and identification system at other deployment points through the information transmission and communication subsystem 40, and guide other mobile photoelectric detection and identification systems to detect the target. When multiple machines detect the target simultaneously, the specific location of the target may be obtained through multi-machine joint positioning.

In order to ensure that optical detection and communication do not interfere with each other, the antennas in the information transmission and communication subsystem 40 may be directly arranged on both sides of the servo cabin dome cover 60, and may rotate together with the servo cabin dome cover 60. The characteristic of this arrangement is that the antenna will not block the optical detection under any circumstances. When the servo turntable adjusts the tracking direction, the position of the antenna is also moving at any time, that is, the optical detection and communication transmission may be carried out quickly without interfering with each other. It is not necessary to arrange the antenna far away from the vehicle manually.

In an embodiment, in order to make the complete machine equipped with global self-inspection capability during operation, as shown in FIG. 1, the vehicle 50 provided in this embodiment may further be provided with an integrated control computer, the integrated control computer is electrically connected with the switch in the information transmission and communication subsystem 40 to control the working status of various subsystems and various modules of the whole machine in real time.

Specifically, the working process of the integrated control computer is as follows: when the whole machine is in working state, the laser receiving module, the infrared wide spectrum measurement module, and the long-wavelength infrared detection module will periodically transmit the working state of the modules to the long-wavelength infrared image co-processing module, the mid-wavelength infrared detection module will periodically transmit the working status to the mid-wavelength infrared image co-processing module, the short-wavelength infrared detection module will periodically transmit the working status to the short-wavelength infrared image co-processing module, the visible light detection module will periodically transmit the working status to the visible light image co-processing module, the four image co-processing modules of the photoelectric parallel processing and identification subsystem 20 will periodically transmit the working status to the information processing main control module. Similarly, the two-axis high-precision control turntable will periodically transmit the working status to the servo main control module. The satellite communication module, the mobile communication module, the wireless transmission module, and the optical access module are directly connected to the switch, and the working status is periodically transmitted the communication main control module through the switch. Through the switch, the servo main control module, the information processing main control module, and the communication main control module, the working status of their corresponding subsystems will be summarized and transmitted to the integrated control computer. Therefore, through the switch or direct connection with the integrated control computer, the integrated control computer may periodically obtain the working status of various subsystems and modules of the whole machine. When an abnormality occurs during the operation, the integrated control computer may quickly locate the abnormal module and start manual investigation.

Furthermore, in order to ensure that the whole machine is able to adapt to complex scenarios, the whole machine may realize power supply. That is to say, an independent electric control module may be further set up on the vehicle 50, including a diesel generator set 51 and an electric control cabinet, and has two power supply modes: direct power supply from mains electricity and diesel power. When operation in urban conditions, power may be supplied directly to other subsystems or modules of the whole machine by connecting the mains electricity to the electric control cabinet. When the whole machine is in the field or there is no external power input, power may be directly generated by the diesel generator set 51 to transmit the power to other subsystems and modules.

Different from the conventional detection system, all subsystems of the mobile photoelectric detection and identification system provided by the present disclosure are integrated on a vehicle 50, thus having high mobility transfer capability, rapid operation and withdrawal capability, and high deployment capability. The high mobility transfer capability is mainly manifested in the fact that all subsystems and modules of the vehicle are integrated on the vehicle installation platform. The driver may directly drive the vehicle to realize the transfer of the whole machine, and quickly transfer to a new deployment point and carry out multi-wavelength band optical information detection and identification of target/background.

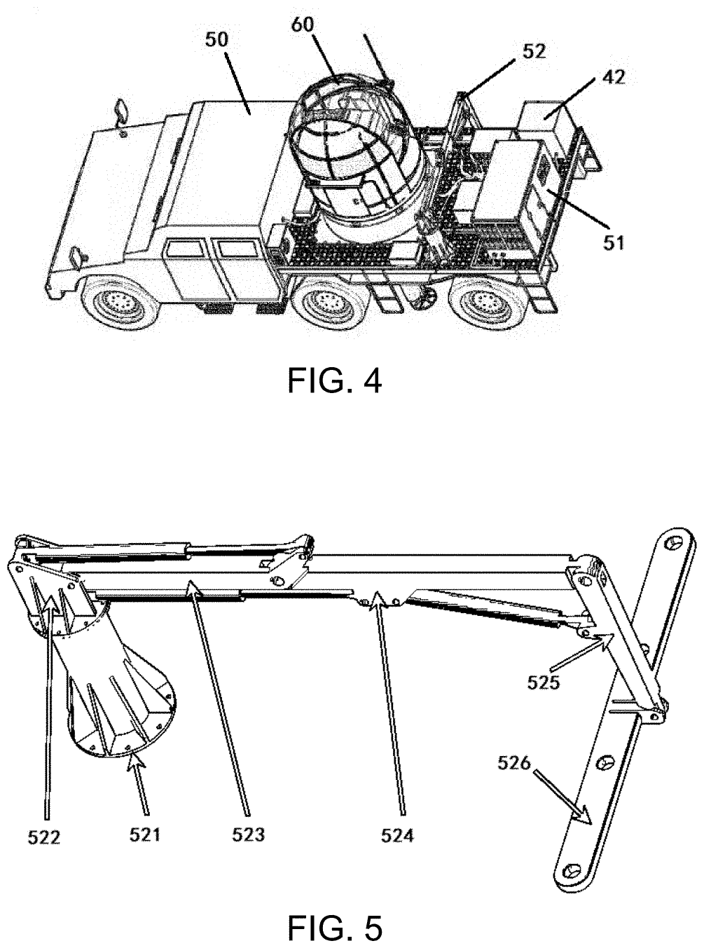

Furthermore, as shown in FIG. 4, a crane 52 and a remote control device may further be provided on the vehicle 50, and the crane 52 is electrically connected to the remote control device and the integrated control computer respectively. The crew may control the crane 52 through the remote control device or the integrated control computer. When the whole machine arrives at the designated deployment location, the staff may transfer the diesel generator set to the ground through the crane 52, so that the vibration of the diesel generator set will not affect the normal operation of other subsystems or modules.

In addition, the optical detection subsystem 10, the photoelectric parallel processing and identification subsystem 20, and the servo subsystem 30 are integrated and installed in a servo cabin dome cover 60. The information transmission and communication subsystem 40 may be integrated and installed in the communication cabinet 42, and antennas in the information transmission and communication subsystem 40 may be integrated and installed on both sides of the servo cabin dome cover 60. The electric control cabinet and the diesel generator set 51 on the vehicle 50 are respectively provided with independent boxes. Therefore, the crane 52 may be used to transfer all subsystems or modules on the vehicle installation platform to other planes such as the ground and the roof, and operate normally under the condition where the power is supplied through the mains electricity or the directly generated by the diesel generator set 51, that is, compared with the entire mobile photoelectric detection and identification system, the vehicle itself, chassis and installation platform are only a platform and carrier, and the rest have both vehicle-mounted and landing capabilities, and have extremely high deployment flexibility.

Specifically, as shown in FIG. 5, the crane 52 may be composed of a base 521, a rotating base 522, a first joint arm 523, a second joint arm 524, a third joint arm 525, a beam 526, and a suspension chain (not shown in the figure). The base 521 is fixed on the installation platform to ensure strength and rigidity, and ensure stability. The rotating base 522 allows the whole crane to rotate within a range of 360°, and the three joint arms are driven by a hydraulic cylinder to realize ascending and lifting by changing the angle. The combined use of the beam 526 and the suspension chain ensures that the surface of the lifted equipment (the servo cabin dome cover 60 and the diesel generator set 51) is protected from bumps and scratches during the lifting process.

Furthermore, when the driver drives the whole machine to the designated deployment location, the crane 52 may be used to transfer the diesel generator set 51 to the ground or other planes, so that the vibration of the diesel generator set 51 will not interfere with the normal operation of other subsystems or modules. According to the requirement of operation, there are mainly three different operation conditions. The whole operation development process is divided into the vehicle-mounted operation of the servo cabin, the landing operation of the servo cabin, and the landing operation of the whole machine respectively. Different operation conditions have different workflows, which are as follows:

(1) Vehicle-mounted operation of the servo cabin: The vehicle is carried to the work site→the diesel generator set is lifted and placed on the ground (the crane is parked after lifting)→the cables and oil pipes are connected and the diesel generator set is activated→the electrical cabinet is activated→the vehicle is levelled→the communication antenna is erected→the servo turntable is levelled→the communication cabinet is activated→the system works normally.

(2) Landing operation of the servo cabin: The vehicle is carried to the work site→the servo cabin dome cover is lifted and placed on the ground (the crane is parked after lifting)→the cables and oil pipes are connected and the diesel generator set is activated→the electrical cabinet is activated→the communication antenna is erected→the servo turntable is levelled→the communication cabinet is activated→the system works normally.

(3) The landing operation of the whole machine: The vehicle is carried to the work site→the servo cabin dome cover, the diesel generator set, the communication cabinet, the electrical cabinet, and various tool boxes are lifted and placed on the ground→the cables and oil pipes are connected and the diesel generator set is activated→the electrical cabinet is activated→the communication antenna is erected→the servo turntable is levelled→the communication cabinet is activated→the system works normally.

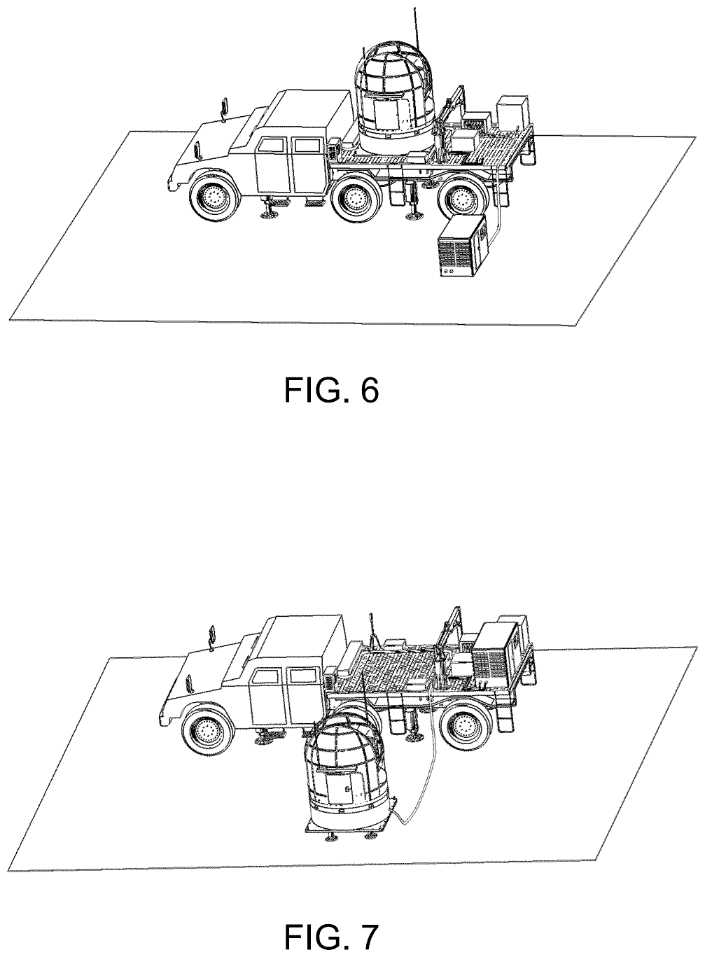

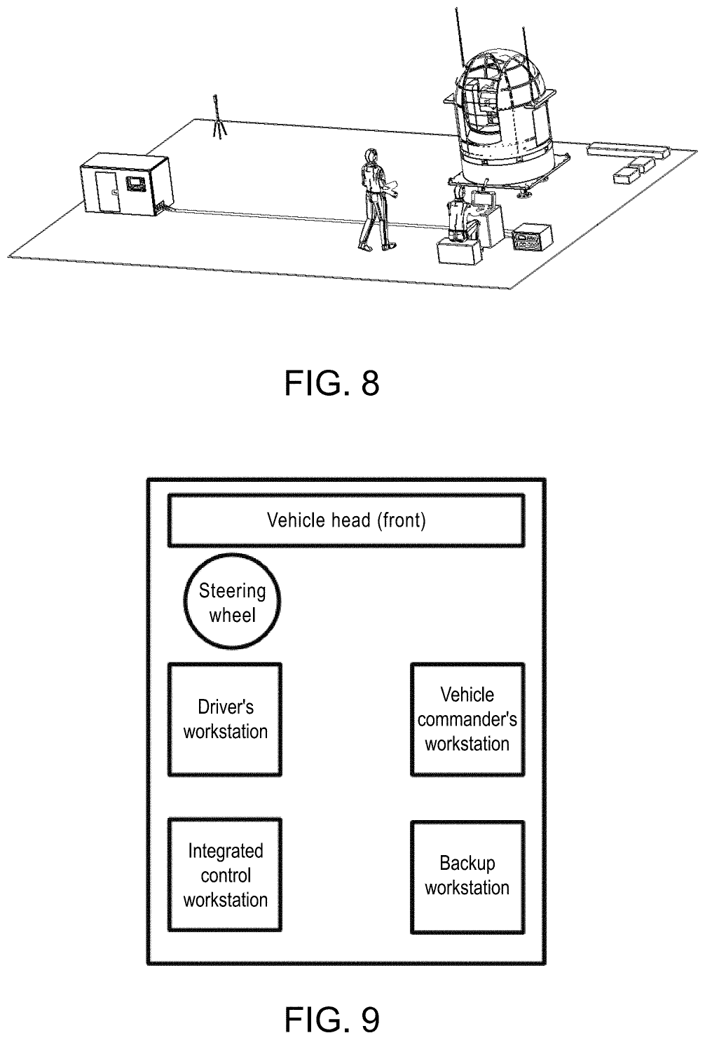

The schematic diagrams under different operation conditions may be shown in FIG. 6 to FIG. 8.

The leveling process of the vehicle should be divided into two stages. The bottom of the vehicle installation platform may be provided with leveling legs, which are able to complete the rough leveling of the installation plane under the vehicle working conditions in a very short time. The servo subsystem 30 is directly configured with a servo fine leveling module and a positioning and orientation module. The positioning and orientation module is configured to obtain the position and direction information of the optical detection subsystem 10, and the servo main control module is configured to control the servo fine leveling module according to the position and direction information to realize the leveling control of the optical detection subsystem 10. The leveling of the servo plane/optical detection subsystem 10 is realized on the basis of the completion of the rough leveling.

In order to arrange the workstations reasonably, in the vehicle, 4 workstations may be provided in the cockpit of the vehicle, respectively corresponding to the driver's workstation, the vehicle commander's workstation, the integrated control workstation, and the backup workstation. The driver's workstation is in the front left of the cockpit and responsible for the driving and control of the vehicle. The captain's station is located on the right side of the driver's station and on the right side of the front row of the cockpit. The integrated control station is located behind the driver's station. The integrated control computer of the whole machine is equipped on the vehicle commander's station and the integrated control station. Under normal circumstances, the computer at the integrated control station controls and dispatch the electronic equipment of the whole machine. The computer at the captain's station serves as a backup integrated control computer or serves other operation purposes. The backup station may be adjusted temporarily as needed, and the specific arrangements are shown in FIG. 9.

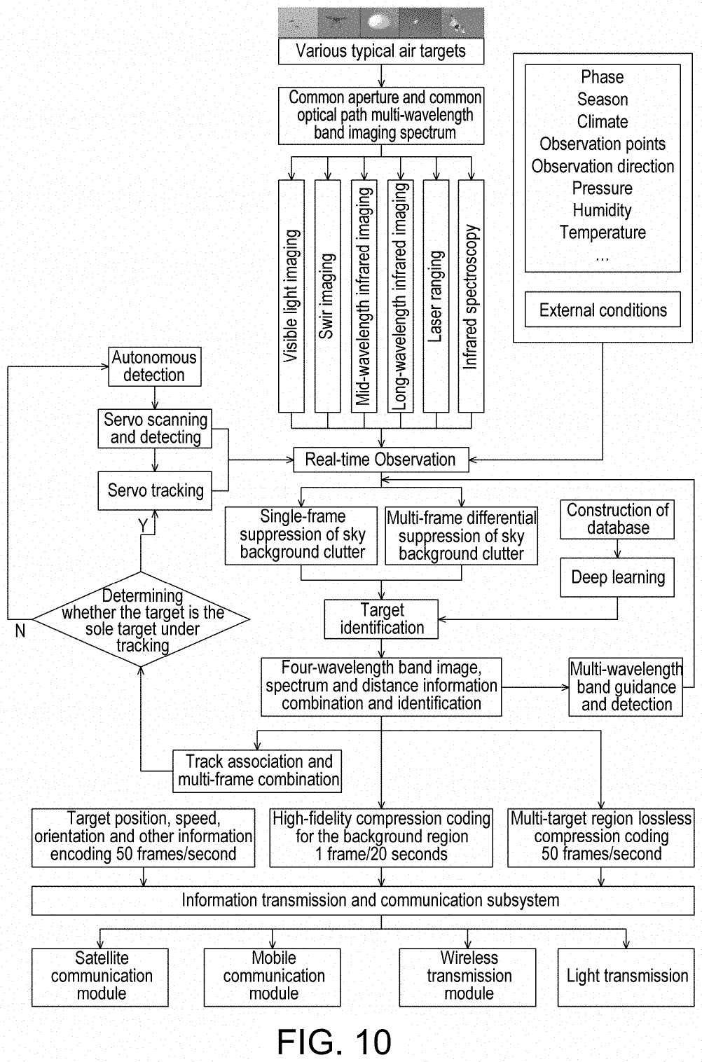

FIG. 10 is a flow chart of detecting air targets as the main detection target provided by the present disclosure, which only serves as a supplementary description of the present disclosure, and does not limit the application the present disclosure (that is, including but not limited to detection of targets on the ground and in the sea).

(1) When the vehicle-mounted equipment is driven to the designated location, the equipment starts working in the corresponding working mode.

(2) The whole machine equipment is able to quickly switch to the specified azimuth for scanning through autonomous servo scanning detection, and scan, detect and identify the specified scene.

(3) The optical detection subsystem 10 will receive multi-wavelength band optical information from the target/background in real time, and transmit the detected multi-wavelength band image information, ranging information, and infrared wide spectrum information to the photoelectric parallel processing and identification subsystem 20 in real time.

(4) After receiving the image of the corresponding wavelength band, each of the image co-processing modules in the photoelectric parallel processing and identification subsystem 20 will detect the air target by means of combining single-frame suppression and multi-frame differential suppression of sky background clutter. This process is mainly composed of DSP and dedicated ASIC for completion, and the detected target will be further identified by FPGA and NPU.

(5) The detection and identification result of each of the image co-processing modules will be transmitted to the information processing main control module, and the information processing main control module will combine the four-wavelength band image detection result, spectral information, and range information for further combined detection and identification, and feedback the position and speed information of the target to each of the image co-processing modules, so as to realize the mutual guidance of multi-wavelength band detection.

(6) In the meantime, the single-frame detection results completed in steps (4) and (5) will be further subjected to track association and multi-frame combination in the information processing main control module. Since the air targets move in a continuous manner, if a “suspected target” does not appear in the field of view for a long time, the “suspected target” will be excluded as a false alarm. In the actual implementation process of the present disclosure, 10 frames of image information will be combined to maximize the exclusion of false alarms and ensure the accuracy of early warning. Only the same “suspected target” which appears continuously in 10 frames will be considered to be the real target.

(7) At the time of performing track association, the photoelectric parallel processing and identification subsystem 20 performs lossless compression encoding on the suspected target region of the image. Lossy compression coding is performed in the background region. The present disclosure performs the JPEG image compression method to achieve lossy/lossless compression of images. Information such as the position, speed, and orientation of the target confirmed through track association and multi-frame combination will also be encoded in real time, and all the above-mentioned encoded packets will be transmitted in a specific format to the information transmission and communication subsystem 40. The information transmission and communication subsystem 40 will perform transmission externally in real time. The information transmission process may freely adopt optical transmission, wireless transmission, mobile communication transmission or satellite communication transmission according to the situation.

(8) After track association and multi-frame combination are performed, the sole target will be determined and tracked stably for a long time. The optical characteristics, position, orientation, speed and other information of the target will be continuously obtained and the corresponding information will be stably transmitted externally.

It is obvious for those skilled in the art that the above descriptions are only preferred embodiments of the present disclosure, and are not intended to limit the present disclosure. Any modifications, equivalent replacements and improvements made within the spirit and principles of the present disclosure should all be included within the protection scope of the present disclosure.

What is claimed is:

1. A mobile photoelectric detection and identification system for a low, slow and small target, comprising: an optical detection subsystem, a photoelectric parallel processing and identification subsystem and a servo subsystem, wherein the optical detection subsystem and the photoelectric parallel processing and identification subsystem are disposed on the servo subsystem, and the servo subsystem is carried on an installation platform of a vehicle, wherein
the optical detection subsystem is configured to collect multi-wavelength band optical information from a target and a background; the multi-wavelength band optical information comprises multi-wavelength band image information, laser ranging information and infrared wide spectrum information, the multi-wavelength band image information comprises long-wavelength infrared image information, mid-wavelength infrared image information, short-wavelength infrared image information and visible light image information;
the photoelectric parallel processing and identification subsystem comprises a multi-wavelength band image co-processing module and an information processing main control module, co-processing modules of various wavelength bands are configured to perform single-frame detection and identification of the target from image information of a corresponding wavelength band by means of single-frame suppression and multi-frame differential suppression of sky background clutter; the information processing main control module is configured to use JPEG image compression, track association and multi-frame combining methods to perform a multi-frame detection and identification on the target according to laser range measurement information, infrared wide spectrum information, image information of the various wavelength bands and single-frame detection and identification results of the co-processing modules of the various wavelength bands, and feedback multi-frame detection and identification results to image co-processing modules of the various wavelength bands and the servo subsystem; the multi-frame detection and identification results comprise orientation information, speed information, height information and position information of the target;
the servo subsystem is configured to complete target tracking according to the multi-frame detection and identification results.

2. The mobile photoelectric detection and identification system for the low, slow and small target according to claim 1, wherein the optical detection subsystem comprises an optical window and a laser emitting module, a six-wavelength band common-aperture Cassegrain reflection module, a beam splitting module, and a six-wavelength band detection module arranged sequentially behind the optical window, wherein the beam splitting module comprises a plurality of reflective and refractive lenses; the six-wavelength band detection module comprises a long-wavelength infrared detection module, a mid-wavelength infrared detection module, a short-wavelength infrared detection module, a visible light detection module, a laser receiving module, and an infrared wide spectrum measurement module, the laser emitting module, the laser receiving module and the infrared wide spectrum measurement module are respectively electrically connected to the information processing main control module, and the long-wavelength infrared detection module, the mid-wavelength infrared detection module, the short-wavelength infrared detection module and the visible light detection module are electrically connected with an image co-processing module of a corresponding wavelength band.

3. The mobile photoelectric detection and identification system for the low, slow and small target according to claim 2, wherein a primary optical aperture of the six-wavelength band common-aperture Cassegrain reflection module is greater than or equal to 500 mm; an emission wavelength band of the laser emitting module is 1.54 μm; a detection wavelength band of the long-wavelength infrared detection module is 8 to 14 μm; a detection wavelength band of the mid-wavelength infrared detection module is 3 to 5 μm; a detection wavelength band of the short-wavelength infrared detection module is 1.3 to 2.2 μm; a detection wavelength band of the visible light detection module is 0.45 to 0.75 μm; a spectrum measurement wavelength band of the infrared wide spectrum measurement module is 1.7 to 14 μm.

4. The mobile photoelectric detection and identification system for the low, slow and small target according to claim 1, wherein the servo subsystem comprises a two-axis high-precision control turntable and a servo main control module, the servo main control module is electrically connected to the two-axis high-precision control turntable and the information processing main control module respectively, the two-axis high-precision control turntable is equipped with a load U-shaped frame, the optical detection subsystem is disposed in the U-shaped frame, and modules in the photoelectric parallel processing and identification subsystem are divided into two information processing chambers disposed on both sides of the U-shaped frame.

5. The mobile photoelectric detection and identification system for the low, slow and small target according to claim 4, wherein the servo subsystem, the optical detection subsystem, and the photoelectric parallel processing and identification subsystem are simultaneously disposed in a servo cabin dome cover, and the servo cabin dome cover is provided with a window that moves with a detection direction of the optical detection subsystem.

6. The mobile photoelectric detection and identification system for the low, slow and small target according to claim 5, further comprising an information transmission and communication subsystem; wherein the information transmission and communication subsystem comprises a switch, a communication main control module and an external transmission module, the switch is electrically connected to the communication main control module, the information processing main control module, and the servo main control module respectively;
during an operation, the information processing main control module is configured to compress and encode the multi-wavelength band optical information and the multi-frame detection and identification results into transmission packets in a specific format and forward the transmission packets to the switch, the switch is configured to transfer all of the encoded transmission packets to the communication main control module, and the communication main control module is configured to complete scheduling and external transmission of all of the transmission packets.

7. The mobile photoelectric detection and identification system for the low, slow and small target according to claim 6, wherein the external transmission module comprises a satellite communication module, a mobile communication module, a wireless transmission module, or an optical access module, the satellite communication module, the mobile communication module, and the wireless transmission module respectively exchange information with each other through an antenna, a control center or other mobile photoelectric detection and identification systems, the optical access module exchanges information with the control center or the other mobile photoelectric detection and identification systems through optical fibers; and the antenna is disposed on both sides of the servo cabin dome cover.

8. The mobile photoelectric detection and identification system for the low, slow and small target according to claim 6, wherein the vehicle is provided with an integrated control computer and an electric control module, and the integrated control computer is electrically connected to the switch and the electric control module respectively,
wherein the integrated control computer is configured to obtain an operation status of various subsystems and various modules in the mobile photoelectric detection and identification system in real time; the electric control module comprises an electric control cabinet and a diesel generator set, and has two power supply modes: direct power supply from mains electricity and diesel power.

9. The mobile photoelectric detection and identification system for the low, slow and small target according to claim 8, wherein a bottom of the installation platform is equipped with leveling legs, and the leveling legs are configured to realize leveling and adjustment of an installation plane of the installation platform;
the servo subsystem further comprises a positioning and orientation module and a servo fine leveling module, wherein the positioning and orientation module is configured to acquire position and direction information of the optical detection subsystem; the servo main control module is configured to control the servo fine leveling module according to the position and direction information to realize leveling control of the optical detection subsystem.

10. The mobile photoelectric detection and identification system for the low, slow and small target according to claim 8, wherein the vehicle is further equipped with a crane and a remote control device, and the crane is electrically connected with the remote control device and the integrated control computer respectively, the crane is configured to receive a lifting command of the remote control device or the integrated control computer to complete a lifting operation of the diesel generator set or the servo cabin dome cover.

11. The mobile photoelectric detection and identification system for the low, slow and small target according to claim 7, wherein the vehicle is provided with an integrated control computer and an electric control module, and the integrated control computer is electrically connected to the switch and the electric control module respectively,
wherein the integrated control computer is configured to obtain an operation status of various subsystems and various modules in the mobile photoelectric detection and identification system in real time; the electric control module comprises an electric control cabinet and a diesel generator set, and has two power supply modes: direct power supply from mains electricity and diesel power.
